(19) United States
(12) Patent Application Publication
(10) Pub. No.: US 2008/0144320 A1
(43) Pub. Date: Jun. 19, 2008

(54) Fixing structure for light emitting diode

(75) Inventor: Hiroto Tokunaga, Hadano-shi (JP)

Correspondence Address: FOLEY AND LARDNER LLP;SUITE 500, 3000 K STREET NW, WASHINGTON, DC, 20007, US

(73) Assignee: ICHIKOH INDUSTRIES, LTD.

(21) Appl. No.: 12/000,372

(22) Filed: Dec. 12, 2007

(30) Foreign Application Priority Data
Dec. 18, 2006 (JP) 2006-340337

(51) Int. Cl. F21V 29/00

(52) U.S. Cl. 362/294

(57) ABSTRACT

A holder in which a light emitting diode is set in an opening is fixed on a heat sink so that power feeding units of the light emitting diode are pushed toward the heat sink by metal wiring bodies. Therefore, the light emitting diode and the heat sink can be brought into close contact with each other and heat dissipation performance of the heat sink can be improved.

### CROSS REFERENCE TO RELATED APPLICATIONS

This application is based upon and claims the benefit of priority from prior Japanese Patent Application P2006-340337 filed on Dec. 18, 2006; the entire contents of which are incorporated by reference herein.

### BACKGROUND OF THE INVENTION

The present invention relates to a fixing structure for a light emitting diode, and, more particularly to a fixing structure for a light emitting diode that is suitable for a vehicle lamp device.

Conventionally, as a fixing structure for a light emitting diode, as disclosed in Japanese Patent Application Laid-Open No. 2006-66108, there is known a structure that a light emitting diode having a power feeding unit on a surface of a substrate is held being sandwiched between an attachment in which a wiring unit to supply power to the light emitting diode is embedded and a bottom-surface supporting member, and the light emitting diode held with the attachment and the bottom-surface supporting member is fixed in a required position such as in a housing or on a heat sink.

### SUMMARY OF THE INVENTION

However, in such a conventional technique, since the light emitting diode is fixed by sandwiching with two parts, when the light emitting diode is fixed to a heat sink, the other part can interfere close attachment of the light emitting diode to a heat sink. Accordingly, the light emitting diode and the heat sink cannot be securely attached to each other in large areas, and sufficient heat dissipation by the heat sink may not be achieved.

Therefore, it is an object of the present invention to obtain a fixing structure for a light emitting diode in which sufficient heat dissipation can be achieved by securely making a light emitting diode and a heat sink closely attach to each other.

A first aspect of the present invention provides a fixing structure for a light emitting diode that includes a light emitting diode in which power feeding units are formed in end portions on both sides in one direction on a surface side; a heat sink to fix the light emitting diode; and an insulating holder that has an opening in a shape matching with a shape of an outline of the light emitting diode and that has predetermined thickness. At each of end portions on both sides in one direction of the holder, a metal wiring body in a form of plate stretching along another direction perpendicular to the one direction is inserted, the metal wiring body is arranged such that at least a side end portion thereof protrudes into the opening, and that an end portion of the metal wiring body in the other direction protrudes externally from the holder as a connecting terminal, and by setting the light emitting diode in the opening of the holder from a side of the heat sink, and by fixing the holder on a surface side of the heat sink with a fixing unit, the power feeding units of the light emitting diode are pushed toward the heat sink through the metal wiring body in the opening.

### BRIEF DESCRIPTION OF THE DRAWINGS

FIG. 1 is a perspective view showing an internal structure of a head lamp to which a fixing structure for a light emitting diode according to an embodiment of the present invention is applied;

FIG. 2 is a perspective view showing the fixing structure for a light emitting diode according to the embodiment;

FIG. 3 is an exploded perspective view showing the fixing structure for a light emitting diode according to the embodiment;

FIG. 4 is a plan view showing a holder housing a light emitting diode in an opening thereof according to the embodiment;

FIG. 5 is a bottom view of the holder and the light emitting diode according to the embodiment;

FIG. 6 is a cross-section taken along a line VI-VI shown in FIG. 4;

FIG. 7 is a cross-section showing a state in which the light emitting diode is removed from the holder according to the embodiment; and

FIG. 8 is a cross-section taken along a line VIII-VIII shown in FIG. 4.

### DETAILED DESCRIPTION OF THE PREFERRED EMBODIMENTS

Embodiments of the present invention will be explained below in detail with reference to the accompanying drawings.

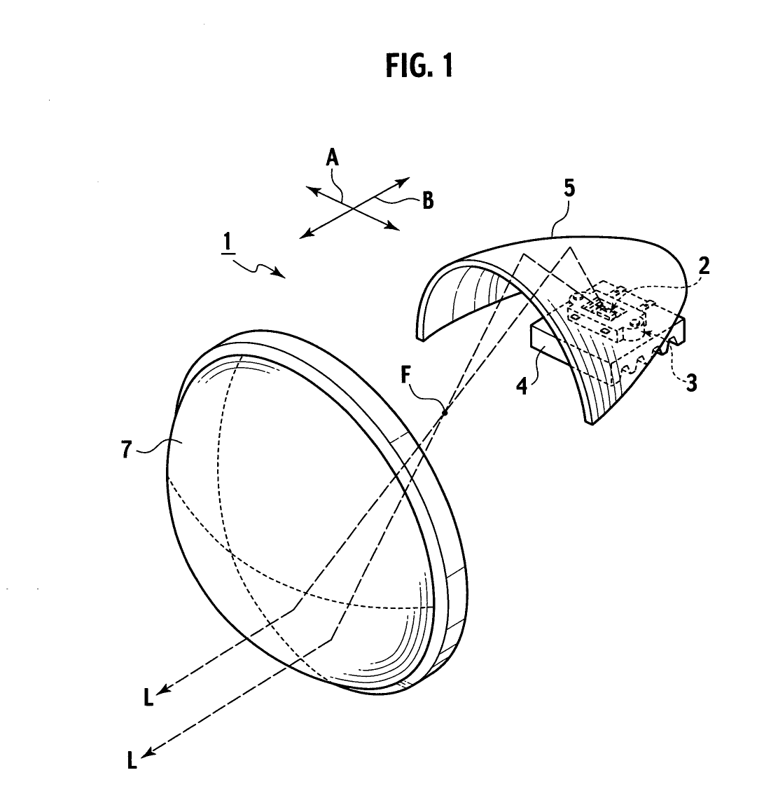

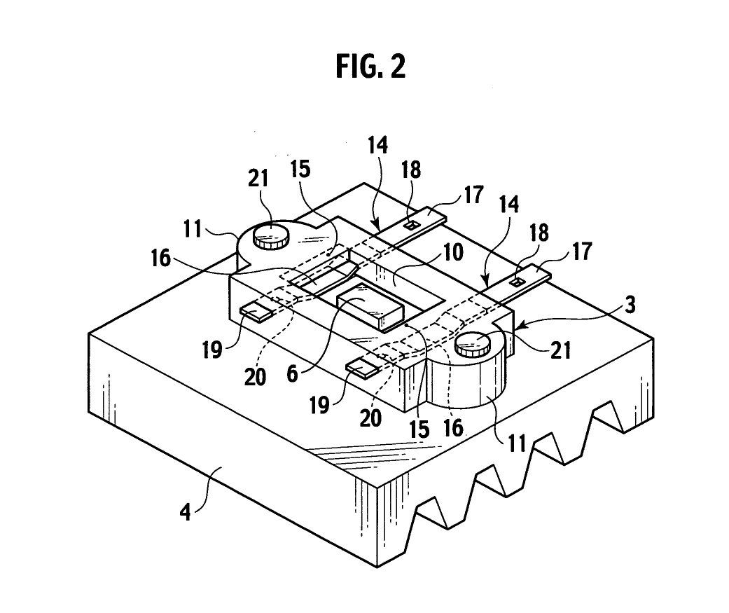

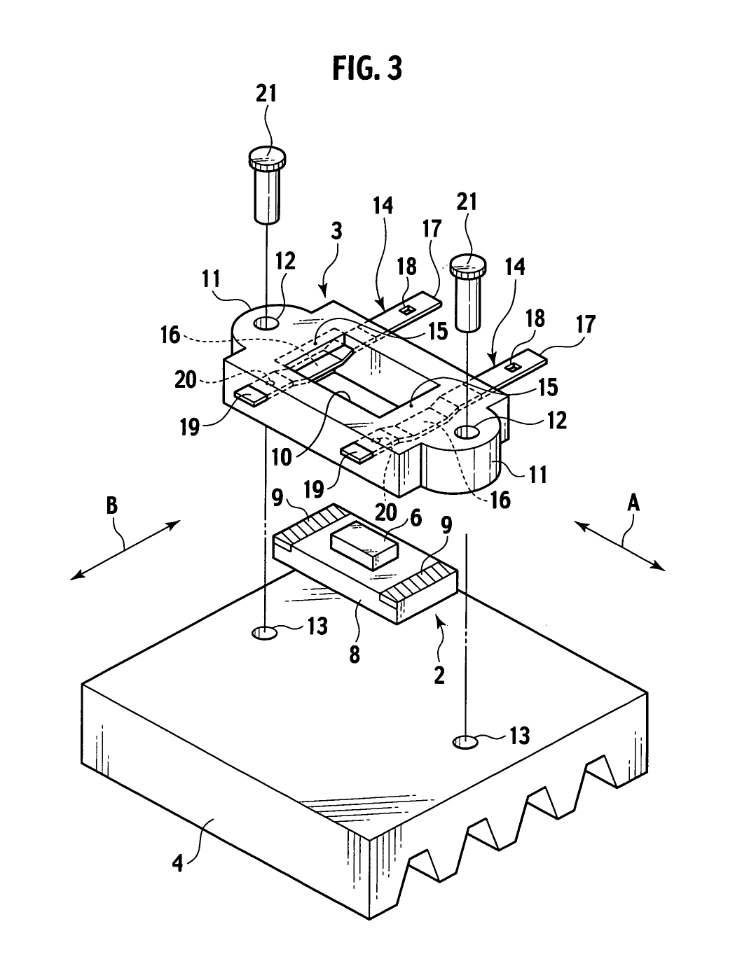

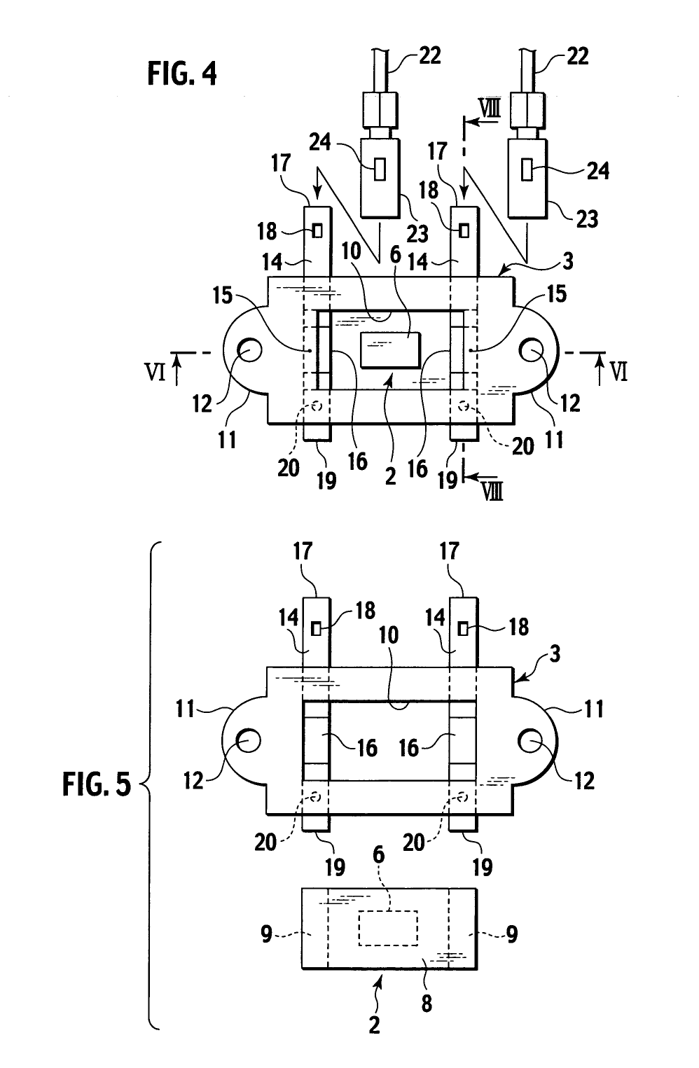

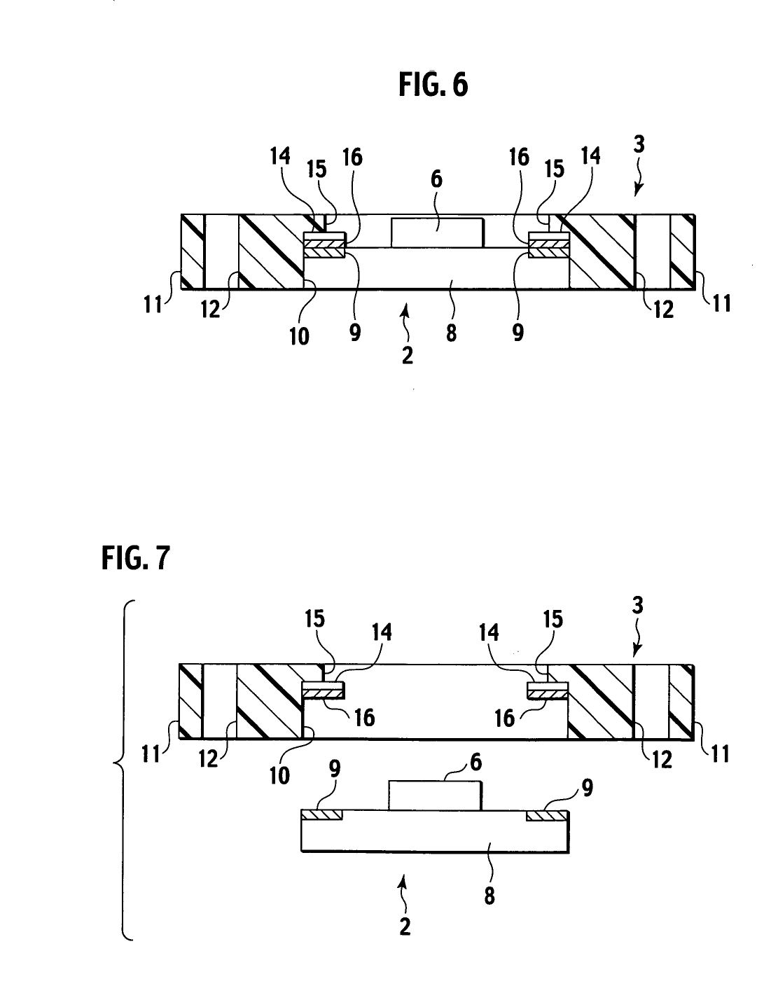

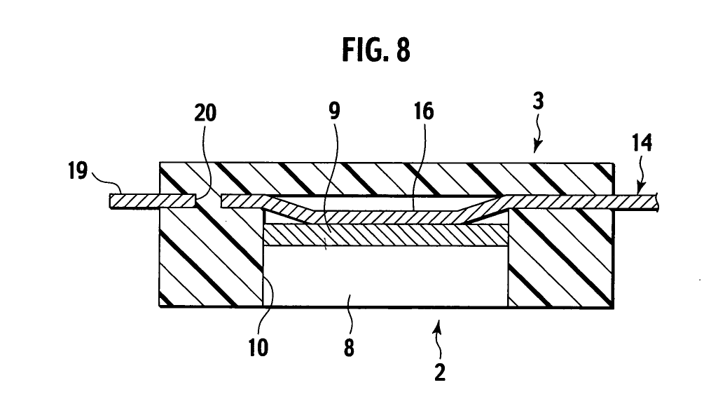

FIG. 1 is a perspective view showing an internal structure of a head lamp to which a fixing structure for a light emitting diode according to an embodiment of the present invention is applied, FIG. 2 is a perspective view showing the fixing structure for a light emitting diode, FIG. 3 is a exploded perspective view showing the fixing structure for a light emitting diode, FIG. 4 is a plan view showing a holder housing a light emitting diode in an opening thereof, FIG. 5 is a bottom view of the holder and the light emitting diode, FIG. 6 is a cross-section taken along a line VI-VI shown in FIG. 4, FIG. 7 is a cross-section showing a state in which the light emitting diode is removed from the holder, and FIG. 8 is a cross-section taken along a line VIII-VIII shown in FIG. 4.

Head lamps that are positioned on both sides in a front part of a vehicle are constituted of a plurality of lamp units. FIG. 1 shows a basic structure of a lamp unit 1, which is one of the lamp units. A light emitting diode 2 is fixed on a top surface of a heat sink 4 with a holder 3 in a state facing upward. On an upper portion of the light emitting diode 2, a reflector 5 having a basically ellipsoidal surface is arranged. A light emitting unit 6 of the light emitting diode 2 is focused on a first focal point of the reflector 5, and light L emitted from the light emitting diode 2 is reflected frontward by the reflector 5.

In front, a projector lens 7 is positioned, and the light L reflected by the reflector 5 passes through a second focal point F, and then is lead into the projector lens 7 to be irradiated forward from a vehicle. A shade (not shown) is provided near the second focal point F, and the light L lead into the projector lens 7 is irradiated forward in a light distribution pattern corresponding to the shape of the shade.

Next, the fixing structure for the light emitting diode 2 is explained. The light emitting diode 2 emits white light, and has such a structure that the light emitting unit 6 smaller than a substrate 8 is mounted on the substrate 8 formed in a rectangular shape in which a side in a vehicle width direction (one direction) A is longer than a side in a front-rear direction (the other direction) B. The substrate 8 is heat conductive, and has power feeding units 9 of cathode and anode on a top surface on both sides in the vehicle width direction.

To fix the light emitting diode 2 to the heat sink 4, the holder 3 made of resin that is an insulating material is used. This holder 3 is basically formed in a rectangular shape, and is a plate-formed member having larger thickness than the substrate 8 of the light emitting diode 2.

An opening 10 is formed in a central part of the holder 3, and fixing portions 11 in a semicircular shape are formed on both sides in the vehicle width direction in a projecting state. In each of the fixing portions 11, a circular fixing hole 12 is formed. On the surface of the heat sink 4, a screw hole 13 corresponding to the fixing hole 12 is formed.

The opening 10 has a rectangular shape that matches the outline of the substrate 8 of the light emitting diode 2. On both sides in the vehicle width direction of the opening 10 of the holder 3, metal wiring bodies 14 in a form of strip-shaped plate are insert-molded in a state of penetrating through the opening 10 in the front-rear direction.

In the present embodiment, a half of the metal wiring body 14 on an outer side in the vehicle width direction is covered with a coating 15 that has the same plane as the surface of the holder 3.

Moreover, in the metal wiring body 14, a spring portion 16 that is bent downward in a trapezoidal shape is formed. In the present embodiment, by exposing the entire width of lower part of the metal wiring body 14 in the opening 10 as shown in FIG. 5, it is structured such that the spring portion 16 is freely deformable inside the opening 10. With an elastic force generated by deformation of the spring portion 16, the power feeding unit 9 of the light emitting diode 2 can be pushed.

A rear end of the metal wiring body 14 protrudes rearward (externally) from the holder 3 as a connecting terminal 17, and a terminal lock hole 18 is formed at that portion. A front end 19 of the metal wiring body 14 protrudes forward a little from the holder 3. At a portion near the front end 19 of the metal wiring body 14 in the holder 3, a positioning hole 20 is formed. The positioning hole 20 is used when the metal wiring body 14 is set in a mold (not shown) to insert-mold in the holder 3.

When the light emitting diode 2 is fixed with the holder 3, first, the light emitting diode 2 is inserted in the opening 10 of the holder 3 from a back side. In the present embodiment, since the opening 10 has a shape matching with the substrate 8 of the light emitting diode 2, the light emitting diode 2 is set precisely fitting in the opening 10. However, the light emitting diode 2 is not completely inserted in the opening 10 in this state, and is in a state in which a back surface thereof protrudes a little from a back surface of the holder 3.

Next, the fixing hole 12 of the holder 3 and the screw hole 13 of the heat sink 4 are put together, and a screw (a fixing means) 21 is inserted from the top and is fastened in the screw hole 13. The holder 3 is pushed toward a surface of the heat sink 4 by a fastening force of the screw 21 and is fixed in a state contacting the heat sink 4.

When the holder 3 is fixed, the spring portion 16 in the opening 10 pushes the power feeding unit 9 of the light emitting diode 2. As a result, the back surface of the substrate 8 of the light emitting diode 2 is securely brought into close contact with the surface of the heat sink 4, and contact between the spring portion 16 (the metal wiring body 14) and the power feeding unit 9 also becomes firm.

After the light emitting diode 2 is fixed with the holder 3, a terminal-lock terminal 23 that is swaged at an end of a harness 22 is inserted in the connecting terminal 17 protruding rearward from the holder 3. At this time, by engaging a hook 24 as an engaging portion that is formed in the terminal-lock terminal 23, in the terminal lock hole 18, the terminal-lock terminal 23 is prevented from coming apart therefrom. By thus connecting the terminal-lock terminal 23 with the connecting terminal 17, power is supplied to the power feeding unit 9 of the light emitting diode 2 through the metal wiring body 14, thereby enabling the light emitting diode 2 to emit light.

According to the present embodiment, just by fixing the holder 3 in which the light emitting diode 2 is set in the opening 10 on the heat sink 4, the power feeding unit 9 of the light emitting diode 2 is pushed toward the heat sink 4 by the metal wiring body 14 in the opening 10. Therefore, the light emitting diode 2 and the heat sink 4 can be brought into close contact with each other and heat dissipation performance by the heat sink 4 can be improved.

Moreover, according to the present embodiment, no extra member is required between the light emitting diode 2 and the heat sink 4. Therefore, the entire rear surface of the substrate 8 of the light emitting diode 2 can closely contact with the heat sink 4, and the heat dissipation performance can be sufficiently improved.

Furthermore, according to the present embodiment, the metal wiring body 14 and the power feeding unit 9 also closely contact with each other. Therefore, performance in feeding power to the light emitting diode 2 is also improved. In the present embodiment, since the metal wiring bodies 14 are insert-molded in the holder 3 in a state of penetrating in the front-rear direction respectively, accuracy in attaching the light emitting diode 2 to the heat sink 4 can be improved, and the performance in feeding power to the light emitting diode 2 can be further improved.

Moreover, since the outlines of the opening 10 of the holder 3 and the light emitting diode 2 match with each other, positioning of the light emitting diode 2 can be accurately performed, thereby improving optical performance.

Furthermore, according to the present embodiment, since the metal wiring bodies 14 penetrate through the opening 10 in the front-rear direction, the spring portions 16 are held at both sides in the front-rear direction of the opening 10, thereby improving holding rigidity of the spring portions 16. Therefore, a pushing force of the spring portions 16 applied to the power feeding units 9 can be enhanced according to a fastening force of the screw 21 of the holder 3.

Moreover, according to the present embodiment, since the spring portion 16 that is bent toward the heat sink 4 is formed in the metal wiring body 14, the power feeding unit 9 of the light emitting diode 2 can be pushed by an elastic force of the spring portion 16. Furthermore, by pushing with the elastic force of the spring portion 16, degradation of the pushing force to the power feeding unit 9 with time can be suppressed. Further, since the spring portion 16 is bent in a trapezoidal shape, an area contacting with the power feeding unit 9 is large, thereby enabling secure supply of power.

Furthermore, according to the present embodiment, by forming the terminal-lock hole 18 in the connecting terminal 17 of the metal wiring body 14, when the terminal-lock terminal 23 is connected thereto, the hook 24 of the terminal-lock terminal 23 engages with the terminal lock hole 18. Therefore, connection can be achieved easily and the terminal-lock terminal 23 can be prevented from coming apart therefrom. Moreover, in the present embodiment, the metal wiring body 14 is arranged to protrude from the rear of the holder 3 to form the connecting terminal 17, and the terminal-lock terminal 23 is connected to the connecting terminal 17. Therefore, the fixing structure for the light emitting diode 2 can be made thinner.

While a preferred embodiment of the present invention has been described above, the invention is not limited to the above embodiment and changes and modifications can be made within the scope of the gist of the present invention.

For example, the metal wiring body 14 can be arranged to be exposed in the entire width thereof in the opening 10, or can be arranged such that only a side end portion corresponding to an inner half of the entire width of the metal wiring body 14 is exposed in the opening 10, while embedding an outer half thereof in the holder 3.

What is claimed is:

1. A fixing structure for a light emitting diode comprising:
a light emitting diode in which power feeding units are formed in end portions on both sides in one direction on a surface side;
a heat sink to fix the light emitting diode; and
an insulating holder that has an opening in a shape matching with a shape of an outline of the light emitting diode and that has predetermined thickness, wherein
at each of end portions on both sides in one direction of the holder, a metal wiring body in a form of plate stretching along another direction perpendicular to the one direction is inserted,
the metal wiring body is arranged such that at least a side end portion thereof protrudes into the opening, and that an end portion of the metal wiring body in the other direction protrudes externally from the holder as a connecting terminal, and
by setting the light emitting diode in the opening of the holder from a side of the heat sink, and by fixing the holder on a surface side of the heat sink with a fixing unit, the power feeding units of the light emitting diode are pushed toward the heat sink through the metal wiring body in the opening.

2. The fixing structure for a light emitting diode according to claim 1, wherein
the metal wiring body is arranged such that at least the side end portion protruding into the opening penetrates the opening in the other direction.

3. The fixing structure for a light emitting diode according to claim 2, wherein
a spring portion that is bent toward the heat sink is formed in the metal wiring body.

4. The fixing structure for a light emitting diode according to claim 3, wherein
the spring portion is bent in a trapezoidal shape.

5. The fixing structure for a light emitting diode according to claim 1, wherein
a terminal-lock hole that engages with an engaging portion of a terminal-lock terminal is formed in the connecting terminal of the metal wiring body.

6. The fixing structure for a light emitting diode according to claim 2, wherein
a terminal-lock hole that engages with an engaging portion of a terminal-lock terminal is formed in the connecting terminal of the metal wiring body.

7. The fixing structure for a light emitting diode according to claim 3, wherein
a terminal-lock hole that engages with an engaging portion of a terminal-lock terminal is formed in the connecting terminal of the metal wiring body.

8. The fixing structure for a light emitting diode according to claim 4, wherein
a terminal-lock hole that engages with an engaging portion of a terminal-lock terminal is formed in the connecting terminal of the metal wiring body.
